(19) United States
(12) Patent Application Publication
(10) Pub. No.: US 2026/0142288 A1
(43) Pub. Date: May 21, 2026

(54) ALKALINE DRY BATTERY

(71) Applicant: Panasonic Intellectual Property Management Co., Ltd., Osaka (JP)

(72) Inventor: KENJI YAMATO, Osaka (JP)

(21) Appl. No.: 19/105,829

(22) PCT Filed: Jun. 26, 2023
(86) PCT No.: PCT/JP2023/023498

§ 371 Date: Feb. 24, 2025

(30) Foreign Application Priority Data
Sep. 7, 2022 (JP) 2022-142117

(51) Int. Cl. H01M 50/184; H01M 6/06; H01M 50/107; H01M 50/152; H01M 50/186; H01M 50/193; H01M 50/197; H01M 50/198; H01M 50/533; H01M 50/559

(52) U.S. Cl. CPC H01M 50/184; H01M 6/06; H01M 50/107; H01M 50/152; H01M 50/186; H01M 50/193; H01M 50/197; H01M 50/198; H01M 50/533; H01M 50/559

(57) ABSTRACT

An alkaline dry battery includes a battery case, a power generating element, and a sealing unit. The sealing unit includes a terminal plate, a current collector joined to the terminal plate, and a gasket. The current collector includes a body portion having a columnar shape. The gasket includes a central cylindrical portion, an outer peripheral portion, and a coupling portion. The coupling portion includes a bent portion that is protruding to bulge toward a bottom portion of the battery case, a first inclined portion that extends from the central cylindrical portion to the bent portion, and a second inclined portion that extends from the bent portion to the outer peripheral portion. The gasket is formed of a polypropylene resin, and a rubber component is dispersed inside the gasket. The following expressions 3≤R≤20 and 0.59×R+128≤θ1≤0.59×R+163 are satisfied where R (%) denotes an abundance ratio of the rubber component to a total of the polypropylene resin and the rubber component and θ1 (°) denotes an internal angle formed by the first inclined portion and the second inclined portion.

### TECHNICAL FIELD

The present disclosure relates to an alkaline dry battery.

### BACKGROUND ART

Since an alkaline dry battery has a large battery capacity and can take out a large current, an alkaline dry battery (alkaline manganese dry battery) is widely used. The alkaline dry battery usually includes a positive electrode, a negative electrode, a separator disposed between the positive electrode and the negative electrode, and an alkaline electrolyte solution. The positive electrode contains, for example, a manganese dioxide as a positive electrode active material. In order to enhance characteristics of the alkaline dry battery, various proposals have been performed in related art.

PTL 1 discloses a gasket “in which, in alkaline battery sealing gasket 33 including peripheral edge packing portion 36 which is interposed between an opening portion of metal battery can 11 which houses power generating element 20 and also serves as a positive electrode terminal and negative electrode terminal 32 in a pressurized state and hermetically seals the opening portion and partition wall portion 37 which isolates a space portion on a back side of the negative electrode terminal and a housing space portion of the power generating element from each other, in the partition wall portion, thin wall portion 38 which breaks in advance in case of an increase in a gas pressure in the housing space portion and has a safety valve function is formed in a groove shape, a groove direction of thin wall portion 38 is the same direction as a resin orientation of the gasket, and an Izod impact value of a resin forming the gasket is in a range from 20 J/m to 60 J/m, inclusive”. The partition wall is bent such that a bottom portion side of the battery can is convex in order to alleviate stress when the opening portion of the battery can is caulked to the gasket.

### CITATION LIST

### Patent Literature

PTL 1: International Publication Pamphlet No. 2004/077592

### SUMMARY OF THE INVENTION

The gasket of the alkaline dry battery has an explosion-proof valve function. When the internal pressure of the battery reaches a predetermined value, the thin wall portion of the gasket breaks to release the pressure. In a case where a polypropylene resin is used as the material of the gasket, since the polypropylene resin has high extensibility and an operating pressure of the explosion-proof valve tends to be high, the rubber component is dispersed in the gasket to stabilize the operating pressure of the explosion-proof valve.

However, the rubber component dispersed in the gasket may be broken by the increase in the internal pressure of the battery to such an extent that the internal pressure does not reach the operating pressure, and a void may be formed. Since such a void forms a moving path of the electrolyte solution, leakage of the electrolyte solution may occur. Such liquid leakage is likely to occur in a portion where stress is likely to concentrate in the gasket.

An alkaline dry battery according to one aspect of the present disclosure includes a battery case including an opening and a bottom portion which is opposite to the opening, a power generating element housed in the battery case, and a sealing unit that seals the opening of the battery case. The sealing unit includes a terminal plate, a current collector joined to the terminal plate, and a gasket. The current collector includes a body portion having a columnar shape extending in an axial direction. The gasket includes a central cylindrical portion through which the body portion of the current collector penetrates, an outer peripheral portion interposed between a peripheral edge portion of the terminal plate and an opening end portion facing the opening of the battery case, and a coupling portion that couples the central cylindrical portion and the outer peripheral portion. The coupling portion includes a bent portion that is convex to bulge toward the bottom portion of the battery case, a first inclined portion that extends from the central cylindrical portion to the bent portion, and a second inclined portion that extends from the bent portion to the outer peripheral portion side. The gasket is formed of a polypropylene resin, and a rubber component is dispersed inside the gasket. The following expressions 3≤R≤20 and 0.59×R+128≤θ1≤0.59×R+163 are satisfied where R (%) denotes an abundance ratio of the rubber component to a total of the polypropylene resin and the rubber component and θ1) (°) denotes an internal angle formed by the first inclined portion and the second inclined portion.

The present disclosure provides an alkaline dry battery in which a polypropylene resin in which a rubber component is dispersed is used for a gasket and liquid leakage is suppressed.

### BRIEF DESCRIPTION OF THE DRAWINGS

FIG. 1 is a front view of a part of an alkaline dry battery according to an exemplary embodiment in section.

FIG. 2 is a cross-sectional view illustrating an example of a main part of the alkaline dry battery according to the exemplary embodiment.

FIG. 3A is a top view of an example of a gasket of the alkaline dry battery according to the exemplary embodiment.

FIG. 3B is an enlarged view of rectangular region v of the gasket illustrated in FIG. 3A.

FIG. 3C is a cross-sectional view taken along line C1-C1 of the gasket illustrated in FIG. 3B.

FIG. 3D is a cross-sectional view taken along line C2-C2 of the gasket illustrated in FIG. 3B.

FIG. 4 is a diagram illustrating a correspondence between internal angle θ1 and abundance ratio R of a rubber component of the alkaline dry battery according to the exemplary embodiment and evaluation results of Examples and Comparative Examples.

### DESCRIPTION OF EMBODIMENT

Hereinafter, exemplary embodiments of the present disclosure will be described with reference to examples, but the present disclosure is not limited to examples to be described below. In the following description, specific numerical values and materials are disclosed as examples in some cases, but other numerical values and materials may be applied as long as the invention according to the present disclosure can be implemented. In this specification, the description “numerical value A to numerical value B” includes a numerical value A and a numerical value B, and can be read as “from numerical value A to numerical value B inclusive”. In the following description, in a case where lower limits and upper limits of numerical values related to specific physical properties, conditions, or the like are illustrated, any of the illustrated lower limits and any of the illustrated upper limits can be freely combined unless the lower limit is equal to or more than the upper limit.

In addition, the present disclosure encompasses a combination of matters recited in two or more claims freely selected from a plurality of claims recited in the appended claims. That is, as long as no technical contradiction arises, matters recited in two or more claims freely selected from a plurality of claims recited in the appended claims can be combined.

In the following description, the terms “containing xxx” or “including xxx” are expressions that encompass “containing xxx (or including xxx)”, “substantially consisting of xxx”, and “consisting of xxx”.

A type of a dry battery is not particularly limited, and may be, for example, any of a D-sized battery to an AAAA-sized battery.

### (Alkaline Dry Battery)

An alkaline dry battery includes a battery case having an opening, a power generating element housed in the battery case, and a sealing unit sealing the opening. The sealing unit includes a terminal plate, a current collector joined to the terminal plate, and a gasket. The battery case has a cylindrical portion and a bottom portion. The power generating element includes a positive electrode, a negative electrode, a separator disposed between the positive electrode and the negative electrode, and an alkaline electrolyte solution. The terminal plate closes the opening of the battery case and functions as a negative electrode terminal. The current collector has a body portion having a columnar shape.

The gasket includes a central cylindrical portion through which the body portion of the current collector penetrates, an outer peripheral portion interposed between a peripheral edge portion of the terminal plate and an opening end portion of the battery case, a coupling portion that couples the central cylindrical portion and the outer peripheral portion, and a thin wall portion formed in a groove shape. The outer peripheral portion has a ring shape, and wraps the peripheral edge portion of the terminal plate from the outer edge side thereof. The coupling portion has also a ring shape. The central cylindrical portion, the outer peripheral portion, and the coupling portion are integrally molded.

The coupling portion has a bent portion that is convex to bulge toward the bottom portion of the battery case. The coupling portion can be divided into a first inclined portion and a second inclined portion with the bent portion as a boundary. The first inclined portion is a portion that extends from the central cylindrical portion to the bent portion. The second inclined portion is a portion that extends from the bent portion to the outer peripheral portion side. The coupling portion is inclined as a whole such that an end portion of the coupling portion on the outer peripheral portion is closer to the bottom portion of the battery case than an end portion on the central cylindrical portion. For example, the coupling portion extends from the end portion of the central cylindrical portion on a side far from the bottom portion of the battery case and is continuous with the end portion of the outer peripheral portion close to the bottom portion of the battery case.

The gasket is made of a polypropylene resin. The polypropylene resin is a resin in which 95 mass % or more and 100% or less is polypropylene. The polypropylene resin may contain a resin component other than the polypropylene, an antioxidant, and the like. A rubber component is dispersed inside the gasket, and forms a sea-island structure in which a polypropylene resin which is a main component of the gasket is a sea portion (matrix) and a rubber component is an island portion. Note that, the gasket may contain a material (for example, a filler) other than the polypropylene resin and the rubber component, but usually, for example, 90 mass % or more of the gasket is the polypropylene resin and the rubber component.

As the internal pressure of the battery increases, stress is intensively applied to the bent portion of the coupling portion, and the coupling portion is deformed such that the first inclined portion and the second inclined portion face the same direction. At this time, the rubber component present in the coupling portion receives compressive stress. When the internal pressure of the battery further increases, the bending of the coupling portion is reversed, and the coupling portion is bent to be convex to bulge toward the opening portion of the battery case. At this time, the rubber component present in the coupling portion receives tensile stress. A deformation amount of the rubber component is the largest at the bent portion. When a shape of the rubber component is spherical, the rubber component changes to an elongated shape at the coupling portion, and breakage occurs. As a result, a void is formed in the bent portion. Since the void forms a moving path of the electrolyte solution, liquid leakage is caused. Such a phenomenon can occur even when the internal pressure increases to such an extent that can occur in normal use.

The formation of the void is more likely to occur as internal angle θ1 formed by the first inclined portion and the second inclined portion in the coupling portion is smaller (that is, as the bending is larger) and as abundance ratio R of the rubber component dispersed in the gasket is larger. In order to suppress the formation of the void, internal angle θ1 formed by the first inclined portion and the second inclined portion may be set as large as possible or abundance ratio R of the rubber component dispersed in the gasket may be set as small as possible not to impair the stability of an operating pressure of the explosion-proof valve.

In the present disclosure, internal angle θ1 formed by the first inclined portion and the second inclined portion is set within a specific range in accordance with abundance ratio R of the rubber component dispersed in the gasket. As a result, the explosion-proof valve operates when the internal pressure of the battery reaches a predetermined pressure, whereas the formation of the void and liquid leakage of the electrolyte solution due to the formation are suppressed when the internal pressure of the battery is equal to or lower than the operating pressure of the explosion-proof valve. That is, it is possible to realize an alkaline dry battery which is excellent in operation performance of an explosion-proof valve and in which liquid leakage is highly suppressed.

Specifically, abundance ratio R (%) of the rubber component to a total of the polypropylene resin and the rubber component and internal angle θ1) (°) formed by the first inclined portion and the second inclined portion satisfy the following Expressions (1) and (2).

$$3 \leq R \leq 20 \qquad ( 1 )$$

$$0.59 \times R + 128 \leq θ1 \leq 0.59 \times R + 163 \qquad ( 2 )$$

In a case where R and θ1 satisfy Expressions (1) and (2), the liquid leakage of the electrolyte solution due to the formation of the void can be suppressed as long as the internal pressure of the battery is equal to or lower than the operating pressure of the explosion-proof valve. On the other hand, when the internal pressure of the battery reaches a predetermined pressure, the explosion-proof valve operates.

When the negative electrode is excessively expanded during discharging, the gasket is compressed, and a larger stress is applied to the gasket. On the other hand, in a case where the acute angle (angle smaller than) 90°) θ2 formed by the axial direction of the central cylindrical portion and the first inclined portion is more than or equal to 20°, stress concentration on the bent portion is easily alleviated. That is, the liquid leakage can be suppressed even in a situation where the liquid leakage is more likely to occur.

In addition, when the positive electrode is excessively expanded at the time of discharge, the gasket is compressed, and stress larger than the gasket is applied. On the other hand, in a case where W/H≥1.0 is satisfied, stress concentration on the bent portion is easily alleviated. That is, the liquid leakage can be suppressed even in a situation where the liquid leakage is more likely to occur.

Here, W is a width of the coupling portion in the radial direction of the central cylindrical portion, and His height H of the coupling portion in the axial direction of the central cylindrical portion. That is, assuming that a position closest to the central cylindrical portion on an upper surface (opening side) of the first inclined portion is X and a position closest to the outer peripheral cylindrical portion on an upper surface (opening side) of the second inclined portion is Y, a difference between a position of position X in the radial direction of the central cylindrical portion and a position of position Y in the radial direction is width W. In addition, a difference between a position of position X in the axial direction of the central cylindrical portion and a position of position Y in the axial direction is height H. It can be said that a rectangle having two sides parallel to the radial direction of the central cylindrical portion and two sides parallel to the axial direction of the central cylindrical portion and in which straight line XY connecting position X and position Y is a diagonal line is desirably a square or a rectangle wide in the radial direction.

Examples of the rubber component to be dispersed in the gasket include natural rubber, an ethylene-propylene copolymer, an ethylene-propylene-diene copolymer, a butadiene polymer, a butadiene-styrene copolymer, a butadiene-acrylonitrile copolymer, a chlorobutadiene polymer, an isoprene polymer, a styrene-isoprene copolymer, an isobutylene polymer, an isobutylene-butadiene copolymer, an isobutylene-isoprene copolymer, an acrylic acid ester polymer, a thiol rubber, a polysulfide rubber, a polyurethane rubber, a polyether rubber, and an epichlorohydrin rubber.

A preferable example of the gasket is a gasket in which a rubber component such as an ethylene-propylene-diene copolymer is dispersed in a matrix of a polypropylene resin.

Note that, the rubber component contained in the gasket can be identified by various analysis methods, for example, methods such as pyrolysis gas chromatograph mass spectrometry (Py-GC/MS), NMR, thermogravimetry (TG), and evolved gas analysis (EGA).

Abundance ratio R of the rubber component to the total of the polypropylene resin and the rubber component is determined by the following method.

First, the alkaline dry battery is disassembled, the gasket is taken out, and a sample of the gasket is acquired. Usually, the rubber component is uniformly dispersed in the gasket, and a content ratio of the rubber component is the same in any region in the gasket. A sample is collected from a portion having a small stress load such as the central cylindrical portion, while avoided is the collection of the sample from the outer peripheral portion compressed between the peripheral edge portion of the terminal plate and the opening end portion of the battery case. A section of the collected sample is formed, and a sectional image is captured with a scanning electron microscope (SEM). An enlargement ratio of the SEM is, for example, 2000 times.

Subsequently, binarization processing of the sectional image is performed with a threshold 110 by using image processing software (ImageJ). By the binarization processing, the rubber component of the sectional image is converted to white, and components other than the rubber component are changed to black. However, in an actual SEM image, only a contour of the rubber component may be displayed, and an inside of the contour may be displayed in substantially the same color as the component other than the rubber component. In this case, in order to treat the inside of the contour as the rubber component, the binarized image is corrected while being collated with the actual SEM image. For example, a region corresponding to the inside of the contour of the rubber component is filled in white. Ratio r of an area of the rubber component (white portion) in the obtained binarized image to an area of the entire binarized image is obtained. Percentage value (%) of ratio r is determined as abundance ratio R of the rubber component (R=r×100).

A thickness of the coupling portion is, for example, 0.6 mm to 0.8 mm in the case of the D-sized battery, 0.4 mm to 0.6 mm in the case of a C-sized battery, and 0.2 mm to 0.5 mm in the case of an AA-sized battery or an AAA-sized battery.

A height of the central cylindrical portion in the axial direction is, for example, 7 mm to 10 mm in the case of the D-sized battery, 6.5 mm to 9.5 mm in the case of the C-sized battery, and 2 mm to 6 mm in the case of the AA-sized battery or the AAA-sized battery.

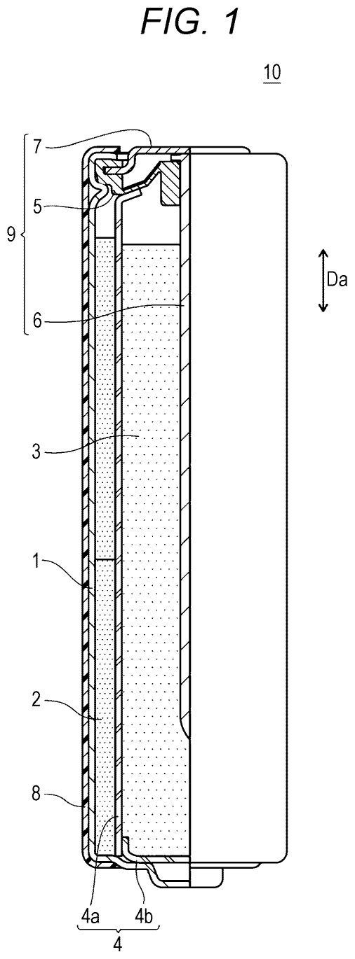

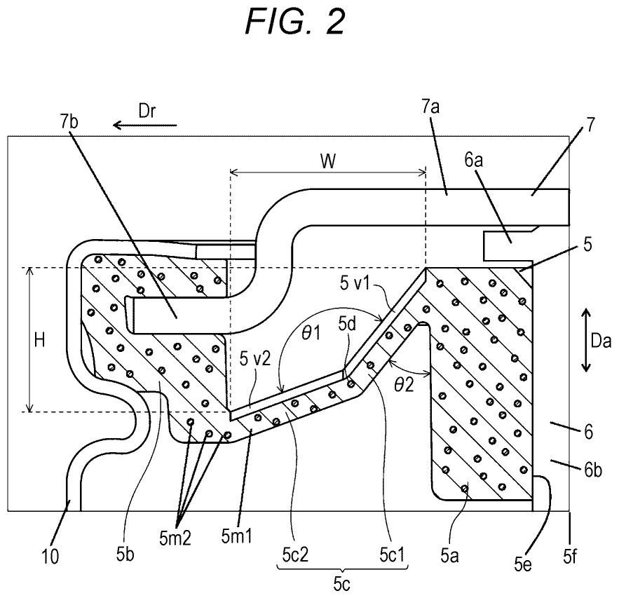

FIG. 1 is a front view of a part of alkaline dry battery 10 according to an exemplary embodiment of the present disclosure in section. FIG. 2 is an enlarged cross-sectional view of a main part of alkaline dry battery 10 of FIG. 1.

Alkaline dry battery 10 having a cylindrical shape includes battery case 1, positive electrode 2, negative electrode (gel negative electrode) 3, separator 4, and an alkaline electrolyte solution (not illustrated). Positive electrode 2, negative electrode (gel negative electrode) 3, separator 4, and an alkaline electrolyte solution (not illustrated) are disposed in battery case 1. Alkaline dry battery 10 has an inside out structure.

Battery case 1 is a case having a bottomed cylindrical shape and functions as a positive electrode terminal. Positive electrode 2 has a hollow cylindrical shape, and is disposed to come into contact with an inner wall of battery case 1. Negative electrode 3 is disposed in a hollow portion of positive electrode 2. Separator 4 is disposed between positive electrode 2 and negative electrode 3.

Separator 4 includes separator 4a having a cylindrical shape and bottom paper 4b. Separator 4a is disposed along an inner surface of the hollow portion of positive electrode 2 to separate positive electrode 2 and negative electrode 3 from each other. Bottom paper 4b is disposed at a bottom portion of the hollow portion of positive electrode 2 to separate negative electrode 3 from battery case 1.

Opening 1a of battery case 1 is sealed by sealing unit 9. Sealing unit 9 includes gasket 5, negative electrode current collector 6, and negative electrode terminal plate 7 functioning as a negative electrode terminal. Negative electrode current collector 6 has a nail shape having head portion 6a and body portion 6b having a columnar shape. Body portion 6b of negative electrode current collector 6 is inserted into through-hole 5e provided in central cylindrical portion 5a of gasket 5 and is inserted into negative electrode 3. Head portion 6a of negative electrode current collector 6 is welded to flat portion 7a at a center of negative electrode terminal plate 7.

Opening end portion facing opening of battery case 1 is caulked to peripheral edge portion 7b (flange portion) of negative electrode terminal plate 7 via an outer peripheral portion of gasket 5. An outer surface of battery case 1 is covered with exterior label 8. Battery case 1, gasket 5, and negative electrode terminal plate 7 constitute a battery housing. Positive electrode 2, negative electrode 3, separator 4, and the alkaline electrolyte solution are power generating elements disposed in the battery housing.

As illustrated in FIG. 2, gasket 5 includes central cylindrical portion 5a, outer peripheral portion 5b, and coupling portion 5c that couples central cylindrical portion 5a and outer peripheral portion 5b. Central cylindrical portion 5a has through-hole 5e, and body portion 6b of negative electrode current collector 6 is inserted into through-hole 5e. Outer peripheral portion 5b is interposed between peripheral edge portion 7b of negative electrode terminal plate 7 and opening end portion 1c of battery case 1, and has a role of sealing between negative electrode terminal plate 7 and opening end portion 1c of battery case 1.

Central cylindrical portion 5a and outer peripheral portion 5b of gasket 5 are continuous via coupling portion 5c. Coupling portion 5c is continuous with central cylindrical portion 5a on an upper side of central cylindrical portion 5a (side far from the bottom portion of the battery case), and is continuous with outer peripheral portion 5b on a lower side of outer peripheral portion 5b (side close to the bottom portion of the battery case). Thus, a boundary position of coupling portion 5c with central cylindrical portion 5a and a boundary position of coupling portion 5c with outer peripheral portion 5b are opposite to each other in an axial direction of central cylindrical portion 5a, and coupling portion 5c is inclined with respect to the axial direction of central cylindrical portion 5a.

Coupling portion 5c has bent portion 5d that is protruding toward the bottom portion of battery case 1. Coupling portion 5c includes first inclined portion 5c1 extending from central cylindrical portion 5a to bent portion 5d and second inclined portion 5c2 extending from bent portion 5d to outer peripheral portion 5b.

Gasket 5 contains polypropylene resin 5m1 and rubber component 5m2 which is dispersed in polypropylene resin 5m1. Polypropylene resin 5m1 is a resin in which 95 mass % or more and 100% or less is composed of polypropylene. Polypropylene resin 5m1 may contain a resin component other than polypropylene, such as an antioxidant. Gasket 5 has a sea-island structure including a sea portion (matrix) which is a main component of gasket 5 made of polypropylene resin 5m1 and an island portion made of rubber component 5m2. Note that, although gasket 5 may contain a material (for example, a filler) other than polypropylene resin 5m1 and rubber component 5m2, most of gasket 5, for example, 90 mass % or more is preferably polypropylene resin 5m1 and rubber component 5m2.

As an internal pressure of battery 10 increases, stress is intensively applied to the bent portion of coupling portion 5c, and coupling portion 5c is deformed such that first inclined portion 5c1 and second inclined portion 5c2 face the same direction. At this time, rubber component 5m2 present in coupling portion 5c receives a compressive stress. When the internal pressure of battery 10 further increases, the bending of coupling portion 5c is reversed, and coupling portion 5c is bent to be protruding to bulge toward opening 1a of battery case 1. At this time, rubber component 5m2 present in coupling portion 5c receives a tensile stress. A deformation amount of rubber component 5m2 is the largest at the bent portion of coupling portion 5c. When a shape of rubber component 5m2 is spherical, rubber component 5m2 may change to an elongated shape at coupling portion 5c, and breakage may occur. As a result, a void is formed in the bent portion of coupling portion 5c.

In coupling portion 5c, internal angle θ1 formed by first inclined portion 5c1 and second inclined portion 5c2, acute angle θ2 formed by first inclined portion 5c1 and axial direction Da of central cylindrical portion 5a, and ratio W/H (see FIG. 2) of width W of coupling portion 5c in radial direction Dr to height H of coupling portion 5c in axial direction Da are controlled in accordance with abundance ratio R of the rubber component, and thus, it is possible to realize alkaline dry battery 10 in which an explosion-proof valve operates when a battery internal pressure reaches a predetermined pressure, whereas the liquid leakage of the electrolyte solution due to the formation of the void is suppressed.

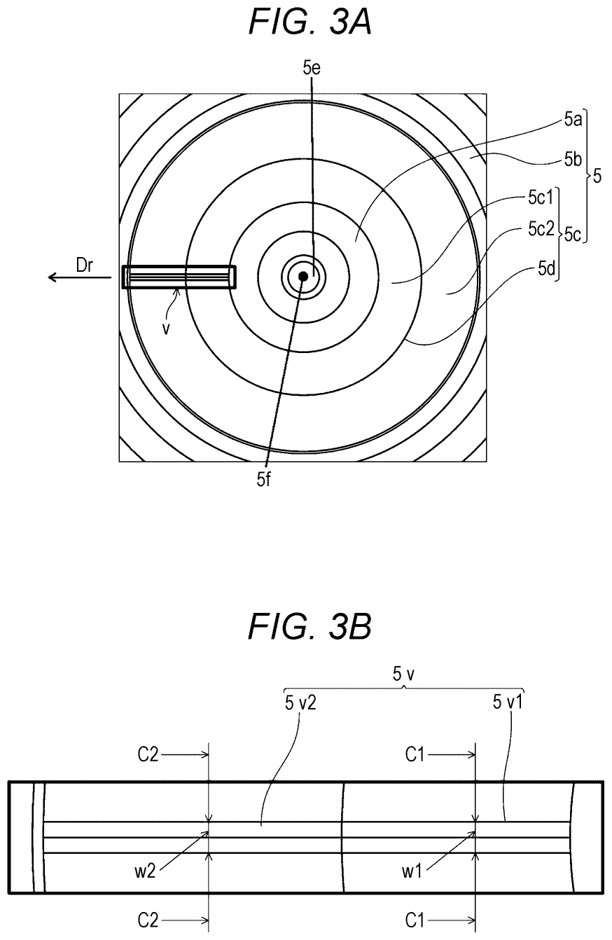

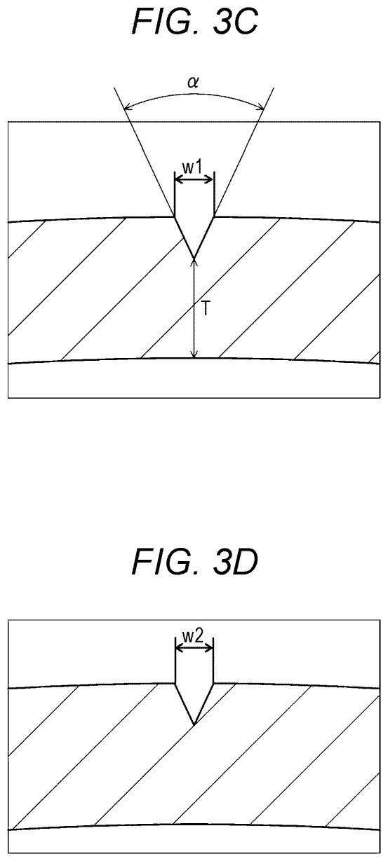

FIG. 3A is a top view of gasket 5. FIG. 3B is an enlarged view of rectangular region v of gasket 5 illustrated in FIG. 3A. FIG. 3C is a cross-sectional view taken along line C1-C1 of gasket 5 illustrated in FIG. 3B. FIG. 3D is a cross-sectional view taken along line C2-C2 of gasket 5 illustrated in FIG. 3B. Thin wall portion 5v locally thin having a groove shape is formed as an explosion-proof valve in coupling portion 5c of gasket 5. Since the explosion-proof valve operates stably, thin wall portion 5v is desirably formed continuously from the bent portion. Thin wall portion 5v extends in radial direction Dr passing through center 5f of central cylindrical portion 5a and has a V-shaped groove shape in cross section. Thin wall portion 5v is formed to extend in radial direction Dr to straddle bent portion 5d, and has portion 5v1 having width w1 and extending from first inclined portion 5c1 in radial direction Dr and portion 5v2 having width w2 and extending from second inclined portion 5c2 in radial direction Dr.

In this case, thickness T of groove-shaped thin wall portion 5v is desirably 100 μm to 300 μm, widths w1 and w2 are desirably 100 μm to 300 μm, and notch angle α of the V shape is desirably 40° to 60°. A length of groove-shaped thin wall portion 5v is preferably 50% to 100% of a length of coupling portion 5c in radial direction Dr. Widths w1 and w2 may be the same as or different from each other.

Note that, the present invention is not limited to the above illustrated example, and two or more groove-shaped thin wall portions may be radially formed. The thin wall portion may be formed in an annular shape along the bent portion. The thin wall portion is configured such that when the battery internal pressure reaches an abnormally large value, the thin wall portion breaks starting from the bent portion to which stress is intensively applied and an internal gas is discharged.

Hereinafter, examples of other configuration elements of the alkaline dry battery according to the present disclosure will be described.

### (Positive Electrode)

The positive electrode contains, for example, a manganese dioxide as a positive electrode active material. The positive electrode usually contains a positive electrode active material and a conductive material, and further contains a binding material as necessary. The positive electrode may be formed by pressure-molding a positive electrode mixture into a body having a cylindrical shape (positive electrode pellet). The positive electrode mixture contains, for example, a positive electrode active material, a conductive material, and an alkaline electrolyte solution, and further contains a binding material as necessary. The cylindrical body may be pressurized to come into close contact with an inner wall of a case body after being housed in the case body.

One preferred example of the manganese dioxide as the positive electrode active material is electrolytic manganese dioxide, but natural manganese dioxide or chemical manganese dioxide may be used. Examples of a crystal structure of the manganese dioxide include α-type, β-type, γ-type, δ-type, ε-type, η-type, λ-type, and ramsdellite-type.

Average particle diameter (D50) of powder of the manganese dioxide may be, for example, in a range from 25 μm to 60 μm, inclusive, from the viewpoint of easily securing the filling property of the positive electrode, the diffusibility of the electrolyte solution in the positive electrode, and the like. Note that, in the present specification, D50 is a median diameter at which a cumulative value in a volume-based particle diameter distribution is 50%.

From the viewpoint of moldability and suppression of expansion of the positive electrode, a BET specific surface area of the manganese dioxide may be, for example, in a range from 20 m²/g to 50 m²/g, inclusive. The BET specific surface area can be measured, for example, by using a specific surface area measuring apparatus by a nitrogen adsorption method.

The conductive material may be a conductive carbon material. Examples of the conductive carbon material include carbon black (acetylene black or the like) and graphite. Examples of the graphite include natural graphite and artificial graphite. A powdery material may be used as the conductive material. Average particle diameter (D50) of the conductive material may be in a range from 3 μm to 20 μm, inclusive. A content of the conductive material in the positive electrode may be in a range from 3 parts by mass to 10 parts by mass, inclusive (for example, in a range from 5 parts by mass to 9 parts by mass, inclusive) with respect to 100 parts by mass of the manganese dioxide.

In order to absorb hydrogen generated inside the battery, a silver compound may be added to the positive electrode. Examples of the silver compound include silver oxide (Ag₂O, AgO, Ag₂O₃, or the like) and silver-nickel composite oxide (AgNiO₂).

### (Negative Electrode)

The negative electrode contains powder of a zinc alloy as a negative electrode active material. The zinc alloy preferably contains at least one selected from the group consisting of indium, bismuth, and aluminum from the viewpoint of corrosion resistance. A content of the indium in the zinc alloy may be, for example, in a range from 0.01 mass % to 0.1 mass %, inclusive. A content of the bismuth in the zinc alloy may be, for example, in a range from 0.003 mass % to 0.02 mass %, inclusive. A content of the aluminum in the zinc alloy may be, for example, in a range from 0.001 mass % to 0.03 mass %, inclusive. Contents of elements other than the zinc in the zinc alloy may be in a range from 0.025 mass % to 0.08 mass %, inclusive from the viewpoint of corrosion resistance.

Average particle diameter (D50) of the zinc alloy powder may be in a range from 100 μm to 200 μm, inclusive (for example, in a range from 110 μm to 160 μm, inclusive) from the viewpoint of the filling property of the negative electrode and the diffusibility of the electrolyte solution in the negative electrode. Note that, in this specification, the average particle diameter is median diameter (D50) at which a cumulative volume is 50% in a volume-based particle diameter distribution. The median diameter is determined, for example, by using a laser diffraction and scattering type particle diameter distribution measuring apparatus.

The negative electrode may contain a gelling agent, a surfactant, and an electrolyte solution in addition to the zinc alloy powder. The negative electrode can be formed by mixing a zinc alloy powder, a gelling agent, a surfactant, and an electrolyte solution. From the viewpoint of more uniformly dispersing an additive (gelling agent, surfactant, or the like) in the negative electrode, the additive is preferably added in advance to the electrolyte solution which is used for producing the negative electrode. An electrolyte solution (alkaline electrolyte solution) which will be described later can be used as the electrolyte solution.

In order to improve corrosion resistance, a compound containing a metal having a high hydrogen overvoltage, such as indium or bismuth, may be appropriately added to the negative electrode.

### (Negative Electrode Current Collector)

A material of the negative electrode current collector may be metal (single metal or alloy). The material of the negative electrode current collector preferably contains copper, and may be an alloy (for example, brass) containing copper and zinc. Plating treatment such as tin plating may be performed on the negative electrode current collector as necessary.

### (Separator)

As the separator, a nonwoven fabric which mainly contains fibers as a main component is used. A resin microporous film is also used as the separator. Examples of a material of the fiber include cellulose and polyvinyl alcohol. The nonwoven fabric may be formed by mixing cellulose fibers and polyvinyl alcohol fibers, or may be formed by mixing rayon fibers and polyvinyl alcohol fibers. Examples of a material of the microporous film include resins such as cellophane and polyolefin. A thickness of the separator may be, for example, in a range from 200 μm to 300 μm, inclusive. In a case where the separator is thin, the thickness may be adjusted to the above thickness by overlapping a plurality of separators.

### (Alkaline Electrolyte Solution)

For example, an alkaline aqueous solution containing potassium hydroxide is used as the electrolyte solution. A concentration of the potassium hydroxide in the alkaline electrolyte solution is preferably in a range from 30 mass % to 50 mass %, inclusive (for example, in a range from 30 mass % to 40 mass %, inclusive). The alkaline electrolyte solution may contain lithium hydroxide (LiOH), sodium hydroxide (NaOH), cesium hydroxide (CsOH), rubidium hydroxide (RbOH), or the like.

The alkaline electrolyte solution may contain a surfactant. The dispersibility of negative electrode active material particles can be enhanced by using the surfactant. The materials exemplified for the negative electrode and the like can be used as the surfactant. A content of the surfactant in the alkaline electrolyte solution is usually in a range of 0 mass % to 0.5 mass %, inclusive (for example, in a range of 0 mass % to 0.2 mass %, inclusive).

### (Battery Housing)

The battery housing includes battery case 1, and the gasket of the sealing unit that seals opening 1a and the negative electrode terminal plate constitute the housing. For example, a metal case having a bottomed cylindrical shape is used as the battery case. For example, a nickel-plated steel plate is used for the metal case. In order to reduce a contact resistance between the positive electrode and the battery case, an inner surface of the battery case may be coated with a carbon film. The negative electrode terminal plate can be made of the same material as the metal case, and can be made of, for example, a nickel-plated steel plate.

A method for assembling alkaline dry battery 10 is not particularly limited, and the technique of the known art can be applied as necessary. For example, the alkaline dry battery may be assembled by a procedure described in the following examples.

Hereinafter, the alkaline dry battery of the present disclosure will be described in more detail based on Examples.

### Examples 1 to 14 and Comparative Examples 1 to 15

An AA cylindrical alkaline dry battery (LR6) illustrated in FIG. 1 was produced according to the following procedures (1) to (3).

### (1) Production of Positive Electrode

A mixture was obtained by adding a graphite powder (average particle diameter (D50) 8 μm) as a conductive agent to an electrolytic manganese dioxide powder (average particle diameter (D50) 35 μm) as a positive electrode active material. A mass ratio of the electrolytic manganese dioxide powder and the graphite powder was 94:6. A positive electrode mixture was obtained by adding an alkaline electrolyte solution to the mixture, sufficiently stirring the mixture, and then compression-molding the mixture into a flake. A mass ratio of the mixture and the alkaline electrolyte solution was 100:3. A solution obtained by adding zinc oxide to a potassium hydroxide aqueous solution was used as the alkaline electrolyte solution. A concentration of the potassium hydroxide in the alkaline electrolyte solution was 40 mass %. A concentration of the zinc oxide in the alkaline electrolyte solution was 7 mass %.

The flake positive electrode mixture was pulverized into granules, and the granules were classified by sieving. Two positive electrode pellets were produced by pressure-molding 6 g of granules obtained by classification with a 10 to 100 mesh sieve into a predetermined hollow cylindrical shape having an outer diameter of 13.5 mm

### (2) Production of Negative Electrode

Gel negative electrode 3 was obtained by mixing zinc alloy powder (average particle diameter (D50) 130 μm) as a negative electrode active material, potassium fluoride as a fluoride, an alkaline electrolyte solution, and a gelling agent. A zinc alloy containing 0.02 mass % of indium, 0.01 mass % of bismuth, and 0.005 mass % of aluminum was used as the zinc alloy. A solution obtained by adding zinc oxide to a potassium hydroxide aqueous solution was used as the alkaline electrolyte solution. A concentration of the potassium hydroxide in the alkaline electrolyte solution was 35 mass %. A concentration of the zinc oxide in the alkaline electrolyte solution was 5 mass %. A mixture of crosslinked branched polyacrylic acid and highly crosslinked sodium polyacrylate was used as the gelling agent. A mass ratio of the negative electrode active material, the alkaline electrolyte solution, and the gelling agent was 170:100:2.5. A content of the potassium fluoride in the negative electrode was set to 0.5 parts by mass per 100 parts by mass of the electrolyte solution.

### (3) Assembly of Alkaline Dry Battery

Battery case 1 was obtained by applying varniphite manufactured by Nippon Graphite Industries, Co., Ltd. to an inner surface of a battery case having a bottomed cylindrical shape (outer diameter: 14 mm, thickness of cylindrical portion: 0.2 mm, height: 50 mm) made of a nickel-plated steel plate to form a carbon film having a thickness of about 10 μm. Two positive electrode pellets were vertically inserted into battery case 1 to form positive electrode 2 in a state of coming into close contact with the inner wall of battery case 1. Separator 4 having a bottomed cylindrical shape was disposed inside positive electrode 2, an alkaline electrolyte solution was injected, and separator 4 was impregnated. Thereafter, 6.5 g of gel negative electrode 3 was filled inside separator 4. A solution obtained by adding zinc oxide to a potassium hydroxide aqueous solution was used as the alkaline electrolyte solution. A concentration of the potassium hydroxide in the alkaline electrolyte solution was 35 mass %. A concentration of the zinc oxide in the alkaline electrolyte solution was 5 mass %.

Bottomed cylindrical separator 4 was formed by using a separator having a cylindrical shape and a bottom paper. A nonwoven fabric sheet (basis weight: 55 g/m²) obtained by mixing rayon fibers and polyvinyl alcohol fibers having a mass ratio of 1:1 as a main component was used as the cylindrical separator and the bottom paper. A thickness of the nonwoven fabric sheet used for the bottom paper was 0.30 mm. The cylindrical separator was formed by overlapping two nonwoven fabric sheets having a thickness of 0.1 mm and winding the overlapped sheets in a double manner.

Negative electrode current collector 6 was obtained by pressing general brass (Cu content: about 65 mass %, Zn content: about 35 mass %) into a nail shape and then performing tin plating on the surface thereof. A diameter of body portion 6b of negative electrode current collector 6 was set to 1.15 mm. Head portion 6a of negative electrode current collector 6 was electrically welded to negative electrode terminal plate 7 made of a nickel-plated steel plate. Thereafter, body portion 6b of negative electrode current collector 6 was press-fitted into through-hole 5e in the central cylindrical portion of gasket 5 made of a polypropylene resin in which an ethylene-propylene-diene polymer (EPDM) was dispersed as a rubber component. In this way, a sealing unit including gasket 5, negative electrode terminal plate 7, and negative electrode current collector 6 was produced.

Subsequently, the sealing unit was installed in opening 1a of battery case 1. At this time, body portion 6b of negative electrode current collector 6 was inserted into negative electrode 3. Opening end portion 1c of battery case 1 was caulked to peripheral edge portion 7b of negative electrode terminal plate 7 via gasket 5 to seal opening 1a of battery case 1. An outer surface of battery case 1 was covered with exterior label 8. In this way, an alkaline dry battery was produced.

As described above, gasket 5 including central cylindrical portion 5a, outer peripheral portion 5b, and coupling portion 5c coupling central cylindrical portion 5a and outer peripheral portion 5b was used. A thin wall portion (explosion-proof valve) having a groove shape is formed in coupling portion 5c to straddle bent portion 5d. Gasket 5 of which a configuration of coupling portion 5c is different was prepared. Specifically, alkaline dry batteries A1 to A14 according to Examples 1 to 14 and alkaline dry batteries B1 to B15 according to Comparative Examples 1 to 15 were produced by setting a combination of internal angle θ1 formed by first inclined portion 5c1 and second inclined portion 5c2 of coupling portion 5c, acute angle θ2 formed by first inclined portion 5c1 and the axial direction of central cylindrical portion 5a, and abundance ratio R of the rubber component contained in gasket 5 to be different as represented in Table 1.

### Example 15

The material of gasket 5 was changed to a polypropylene resin in which a butadiene-styrene copolymer (SBR) was dispersed as a rubber component. In addition, internal angle θ1, acute angle θ2, and abundance ratio R of the rubber component were changed as represented in Table 1. Alkaline dry battery A15 according to Example 15 was prepared in the same manner as in Example 1 except for the above conditions.

### Example 16

The material of gasket 5 was changed to a polypropylene resin in which a styrene-isoprene copolymer (SIS) was dispersed as a rubber component. In addition, internal angle θ1, acute angle θ2, and abundance ratio R of the rubber component were changed as represented in Table 1. Alkaline dry battery A16 according to Example 16 was prepared in the same manner as in Example 1 except for the above condition.

Alkaline dry batteries A1 to A16 and B1 to B15 were evaluated as described in the following (4) and (5).

### (4) Evaluation 1: Constant Current Charging Test

Ten batteries having an identical configuration were prepared. An unused alkaline dry battery was placed in an environment of 25° C. and forcibly charged at a constant current of 200 mA for 1 hour. A battery in which the thin wall portion of the gasket was broken during charging and a state where the sealing unit sealed the opening of the battery case was maintained was regarded as a good product, and a battery in which the thin wall portion was not broken and the sealing unit was detached from the opening of the battery case and the opening was opened was regarded as a defective product. A proportion of batteries determined to be defective among ten batteries was evaluated.

### (5) Evaluation 2: Overdischarge Liquid Leakage Test

Ten batteries having an identical configuration were prepared. An unused alkaline dry battery was placed in an environment of 45° C., was connected to a resistance load of 40 Ω, and was discharged until a voltage between terminals reached 0.05 V. Thereafter, the alkaline dry battery was left at 45° C. for 3 months. Whether the liquid leakage of the alkali electrolyte solution occurred from the battery after being left was visually confirmed. A battery in which the liquid leakage did not occur was regarded as a good product, and a battery in which the liquid leakage occurred was regarded as a defective product. A proportion of batteries determined to be defective among ten batteries was evaluated.

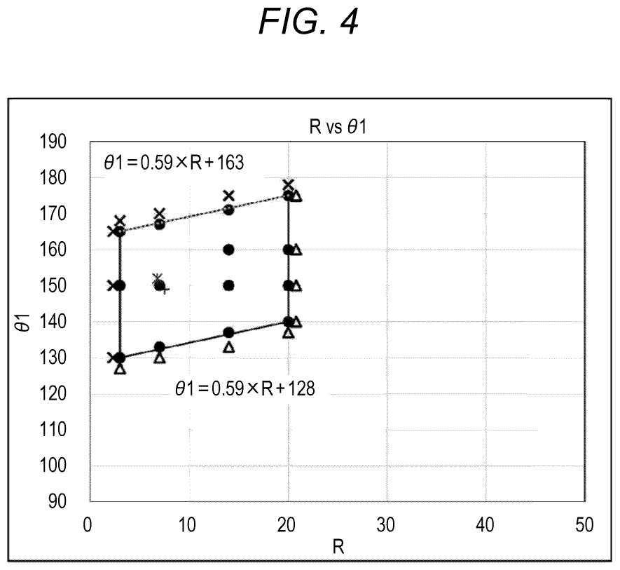

FIG. 4 illustrates a correspondence between internal angle θ1 and abundance ratio R of the rubber component, and the evaluation results of Examples and Comparative Examples. In FIG. 4, “•” (middle dot) is a plot of an example in which neither breakage nor liquid leakage occurred, “+” is a plot of Example 15, “*” is a plot of Example 16, “Δ” (triangle) is a plot of a comparative example in which liquid leakage occurred, and “×” is a plot of a comparative example in which breakage occurred. It can be understood from FIG. 4 that a liquid leakage property is enhanced without inhibiting an operation of the explosion-proof valve as long as Expressions (1) and (2) are satisfied.

TABLE 1

| | | | | | | | | | Liquid |
|---|---|---|---|---|---|---|---|---|---|
| | | | | | | | | Opening | leakage |
| | | | | | | | Rubber | occurrence | occurrence |
| | R | θ1 | θ2 | W | H | W/H | component | rate | rate |
| Example 1 | 7.0 | 150 | 40.4 | 2.68 | 1.99 | 1.35 | EPDM | 0/10 | 0/10 |
| Example 2 | 7.0 | 133 | 34.5 | 2.68 | 1.99 | 1.35 | EPDM | 0/10 | 0/10 |
| Example 3 | 7.0 | 167 | 48.2 | 2.68 | 1.99 | 1.35 | EPDM | 0/10 | 0/10 |
| Example 4 | 14.0 | 137 | 35.7 | 2.68 | 1.99 | 1.35 | EPDM | 0/10 | 0/10 |
| Example 5 | 14.0 | 150 | 42.5 | 2.68 | 1.99 | 1.35 | EPDM | 0/10 | 0/10 |
| Example 6 | 14.0 | 160 | 44.8 | 2.68 | 1.99 | 1.35 | EPDM | 0/10 | 0/10 |
| Example 7 | 14.0 | 171 | 50.4 | 2.68 | 1.99 | 1.35 | EPDM | 0/10 | 0/10 |
| Example 8 | 3.0 | 130 | 33.6 | 2.68 | 1.99 | 1.35 | EPDM | 0/10 | 0/10 |
| Example 9 | 3.0 | 150 | 39.3 | 2.68 | 1.99 | 1.35 | EPDM | 0/10 | 0/10 |
| Example 10 | 3.0 | 165 | 47.2 | 2.68 | 1.99 | 1.35 | EPDM | 0/10 | 0/10 |
| Example 11 | 20.0 | 140 | 36.7 | 2.68 | 1.99 | 1.35 | EPDM | 0/10 | 0/10 |
| Example 12 | 20.0 | 150 | 42.5 | 2.68 | 1.99 | 1.35 | EPDM | 0/10 | 0/10 |
| Example 13 | 20.0 | 160 | 44.8 | 2.68 | 1.99 | 1.35 | EPDM | 0/10 | 0/10 |
| Example 14 | 20.0 | 175 | 52.6 | 2.68 | 1.99 | 1.35 | EPDM | 0/10 | 0/10 |
| Example 15 | 7.5 | 149 | 40.4 | 2.68 | 1.99 | 1.35 | SBR | 0/10 | 0/10 |
| Example 16 | 6.8 | 152 | 40.4 | 2.68 | 1.99 | 1.35 | SIS | 0/10 | 0/10 |
| Comparative | 20.8 | 140 | 36.7 | 2.68 | 1.99 | 1.35 | EPDM | 0/10 | 3/10 |
| Example 1 | | | | | | | | | |
| Comparative | 20.8 | 150 | 42.5 | 2.68 | 1.99 | 1.35 | EPDM | 0/10 | 3/10 |
| Example 2 | | | | | | | | | |
| Comparative | 20.8 | 160 | 44.8 | 2.68 | 1.99 | 1.35 | EPDM | 0/10 | 2/10 |
| Example 3 | | | | | | | | | |
| Comparative | 20.8 | 175 | 44.8 | 2.68 | 1.99 | 1.35 | EPDM | 0/10 | 1/10 |
| Example 4 | | | | | | | | | |
| Comparative | 3.0 | 127 | 32.8 | 2.68 | 1.99 | 1.35 | EPDM | 0/10 | 1/10 |
| Example 5 | | | | | | | | | |
| Comparative | 7.0 | 130 | 33.6 | 2.68 | 1.99 | 1.35 | EPDM | 0/10 | 2/10 |
| Example 6 | | | | | | | | | |
| Comparative | 14.0 | 133 | 34.5 | 2.68 | 1.99 | 1.35 | EPDM | 0/10 | 2/10 |
| Example 7 | | | | | | | | | |
| Comparative | 20.0 | 137 | 35.7 | 2.68 | 1.99 | 1.35 | EPDM | 0/10 | 3/10 |
| Example 8 | | | | | | | | | |
| Comparative | 2.3 | 130 | 33.6 | 2.68 | 1.99 | 1.35 | EPDM | 1/10 | 0/10 |
| Example 9 | | | | | | | | | |
| Comparative | 2.3 | 150 | 42.5 | 2.68 | 1.99 | 1.35 | EPDM | 2/10 | 0/10 |
| Example 10 | | | | | | | | | |
| Comparative | 2.3 | 165 | 47.2 | 2.68 | 1.99 | 1.35 | EPDM | 3/10 | 0/10 |
| Example 11 | | | | | | | | | |
| Comparative | 3.0 | 168 | 48.7 | 2.68 | 1.99 | 1.35 | EPDM | 3/10 | 0/10 |
| Example 12 | | | | | | | | | |
| Comparative | 7.0 | 170 | 49.8 | 2.68 | 1.99 | 1.35 | EPDM | 3/10 | 0/10 |
| Example 13 | | | | | | | | | |
| Comparative | 14.0 | 175 | 52.6 | 2.68 | 1.99 | 1.35 | EPDM | 3/10 | 0/10 |
| Example 14 | | | | | | | | | |
| Comparative | 20.0 | 178 | 54.3 | 2.68 | 1.99 | 1.35 | EPDM | 2/10 | 0/10 |
| Example 15 | | | | | | | | | |

### Examples 17 to 22 and Comparative Example 16

In order to perform evaluation in a situation where liquid leakage is more likely to occur, a filling amount of each of the positive electrode and the negative electrode was increased by 2 mass %. In addition, internal angle θ1, acute angle θ2, and abundance ratio R of the rubber component were changed as represented in Table 2. Alkaline dry batteries A17 to A22 according to Examples 17 to 22 were prepared and evaluated in the same manner as in Example 1 except for the above condition.

Note that, a battery of Comparative Example 16 has the same configuration as the configuration of Comparative Example 1 except that the filling amounts of the positive electrode and the negative electrode are each increased by 2 mass % as compared with the battery of Comparative Example 1.

TABLE 2

| | | | | | | | | | Liquid |
|---|---|---|---|---|---|---|---|---|---|
| | | | | | | | | Breakage | leakage |
| | | | | | | | Rubber | occurrence | occurrence |
| | R | θ1 | θ2 | W | H | W/H | component | rate | rate |
| Comparative | 20.8 | 140 | 36.7 | 2.68 | 1.99 | 1.35 | EPDM | 0/10 | 10/10 |
| Example 16 | | | | | | | | | |
| Example 17 | 20.0 | 130 | 18.0 | 2.68 | 2.60 | 1.03 | EPDM | 0/10 | 2/10 |
| Example 18 | 20.0 | 130 | 19.0 | 2.68 | 2.60 | 1.03 | EPDM | 0/10 | 1/10 |
| Example 19 | 20.0 | 130 | 20.0 | 2.68 | 2.60 | 1.03 | EPDM | 0/10 | 0/10 |
| Example 20 | 20.0 | 137 | 20.0 | 2.68 | 2.88 | 0.93 | EPDM | 0/10 | 2/10 |
| Example 21 | 20.0 | 134 | 20.0 | 2.68 | 2.78 | 0.96 | EPDM | 0/10 | 1/10 |
| Example 22 | 20.0 | 132 | 20.0 | 2.68 | 2.68 | 1.00 | EPDM | 0/10 | 0/10 |

It can be understood from Table 2 that a liquid leakage property is remarkably enhanced without inhibiting an operation of the explosion-proof valve as long as Expressions (1) and (2) are satisfied even under a condition that the positive electrode and the negative electrode are excessively expanded and the gasket is compressed at the time of discharge.

### INDUSTRIAL APPLICABILITY

The alkaline dry battery according to the present disclosure is useful as a power source for various electronic devices because the alkaline dry battery is excellent in operation performance of an explosion-proof valve and is highly suppressed in liquid leakage.

### REFERENCE MARKS IN THE DRAWINGS

1 battery case
2 positive electrode
3 negative electrode
4 separator
5 gasket
5a central cylindrical portion
5b outer peripheral portion
5c coupling portion
5c1 first inclined portion
5c2 second inclined portion
5d bent portion
6 negative electrode current collector
7 negative electrode terminal plate
8 exterior label
9 sealing unit
10 alkaline dry battery

1. An alkaline dry battery comprising:
a battery case including an opening and a bottom portion which is opposite to the opening;
a power generating element housed in the battery case; and
a sealing unit that seals the opening of the battery case,
wherein
the sealing unit includes a terminal plate, a current collector joined to the terminal plate, and a gasket,
the current collector includes a body portion having a columnar shape extending in an axial direction,
the gasket includes a central cylindrical portion through which the body portion of the current collector penetrates, an outer peripheral portion interposed between a peripheral edge portion of the terminal plate and an opening end portion facing the opening of the battery case, and a coupling portion that couples the central cylindrical portion and the outer peripheral portion,
the coupling portion includes:
a bent portion that is protruding to bulge toward the bottom portion of the battery case;
a first inclined portion that extends from the central cylindrical portion to the bent portion;
a second inclined portion that extends from the bent portion to the outer peripheral portion side; and
a thin wall portion locally thin and formed in a groove shape,
the gasket is formed of a polypropylene resin,
a rubber component is dispersed inside the gasket, and
the following expressions are satisfied:
$$3 \leq R \leq 20$$
$$0.59 \times R + 128 \leq θ1 \leq 0.59 \times R + 163.$$
where
R (%) denotes an abundance ratio of the rubber component to a total of the polypropylene resin and the rubber component and
θ1 (°) denotes an internal angle formed by the first inclined portion and the second inclined portion.

2. The alkaline dry battery according to claim 1, wherein
the axial direction of the central cylindrical portion and the first inclined portion form an acute angle of 20° or more.

3. The alkaline dry battery according to claim 1, wherein
W/H≥1.0 is satisfied,
where
W denotes a width of the coupling portion in a radial direction of the central cylindrical portion and
H denotes a height of the coupling portion in the axial direction of the central cylindrical portion.
